(19) United States
(12) Patent Application Publication
(10) Pub. No.: US 2005/0023506 A1
(43) Pub. Date: Feb. 3, 2005

(54) Organic corrosion inhibitors and corrosion control methods for water systems

(75) Inventors: Shintaro Someya, Tokyo (JP); Masato Tsuji, Tokyo (JP); Hiroshi Takahashi, Tokyo (JP)

Correspondence Address: Howard C. Lee;30th Floor, 220 East 42nd Street, New York, NY, 10017, US

(73) Assignee: Organo Corporation, Tokyo (JP)

(21) Appl. No.: 10/933,675

(22) Filed: Sep. 3, 2004

Related U.S. Application Data
(62) Division of application No. 10/248,909, filed on Feb. 28, 2003.

(30) Foreign Application Priority Data
Mar. 1, 2002 (JP) 2002-56137

(51) Int. Cl. C09K 3/00; C23F 11/00

(52) U.S. Cl. 252/388; 422/17

(57) ABSTRACT

A specific monocarboxylic acid with even-numbered carbon atoms, sebacic acid, or a salt thereof is used as a corrosion inhibitor. Alternatively, a specific aliphatic monocarboxylic acid, sebacic acid, or a salt thereof is blended with a specific aliphatic oxycarboxylic acid, a specific polycarboxylic acid, or a salt thereof to prepare a corrosion inhibitor. These corrosion inhibitors can be used in a cooling water system using low-hardness water and in water systems wherein a water flow velocity above a given level cannot always be secured, whereby a high corrosion control performance can be exhibited without imposing unfriendly loads on the environment.

### BACKGROUND OF THE INVENTION

Cooling water is used widely for cooling of apparatuses in various facilities, factories, etc. In most cases of such cooling water systems, pipes and heat exchangers are formed of soft steel and a cupreous metal such as copper or a copper alloy, respectively. How to prevent corrosion of such metal pipes and heat exchangers is one big problem involved in cooling water systems. In general, hardness components such as calcium, which usually exist in cooling water used in a cooling water system, are concentrated through evaporation of part of water in a cooling tower for effecting cooling unless part of cooling water is forcibly replaced afresh. Since water containing much hardness components generally hardly corrodes metals, corrosion control can be achieved by properly concentrating cooling water to heighten the hardness component concentration thereof. In such a system, therefore, addition of a water-soluble polymer dispersant alone for preventing scaling causative of occlusion of piping and a difficulty in heat transfer by a heat exchanger may be able to prevent troubles with the cooling water system.

On the other hand, where highly corrosive water, such as water recovered from processing washing water in a semiconductor factory, is used as make-up cooling water, the water quality thereof generally involves a low salt concentration, and hence the circulating water of cooling water, even if concentrated for operation, is highly corrosive because of its low hardness (at most 200 mg as CaCO₃/liter in total hardness). Where such water is used as cooling water, available corrosion control methods are limited, and a passivation corrosion control method wherein an oxide film is formed using a molybdate or the like is adopted in most cases. Closed cooling water, cool or warm air-conditioning water, or the like, which is not concentrated because its system has no cooling tower, is highly corrosive low-hardness water (at most 200 mg as CaCO₃-/liter in total hardness). Besides, with very limited replenishment of water and chemical agents and often intermittent running conditions which fail to always secure a given level of water flow velocity, a passivation corrosion control method using a chemical agent such as a molybdate, a nitrite or the like is adopted in most cases.

In recent years when the environmental problems have attracted much attention, however, there is an active trend of decreasing the quantity of wastewater containing harmful substances and the like to be discharged out of the systems from various facilities and factories, and conventional corrosion control methods, which impose unfriendly loads on the environment, have been reconsidered.

Corrosion control methods wherein a phosphate (+zinc salt) is used as an alternative to the molybdate or the nitrite have been proposed in some cases. However, phosphorus as well as nitric compounds are substances controlled under the Water Pollution Prevention Law because they causes eutrophication if they are discharged into sea, rivers, lakes and marshes, while zinc salts that are heavy metal salts like molybdates are designated chemical substances according to the PRTR Law (a kind of waste control law concerning “Pollutant Release and Transfer Registration”). Thus, these chemicals are all undesirable because they impose unfriendly loads on the environment. From the standpoint of corrosion control performance as well, the phosphate (+zinc salt) corrosion control methods are disadvantageous in that a proper corrosion-proofing effect cannot be secured because any dense anticorrosive film of calcium phosphate cannot be formed unless water contains a certain level of hardness components (more than 200 mg as CaCO₃/liter). Furthermore, any overfeed of a phosphate and a zinc salt induces scaling of zinc phosphate and hence is not a safe alternative corrosion control method.

An alternative method of preventing corrosion with a polymer is sometimes adopted. Examples of such a polymer include polymers obtained by polymerizing a carboxyl group-containing monomer such as maleic acid, acrylic acid, methacrylic acid or itaconic acid, and copolymers obtained by copolymerizing such a carboxyl group-containing monomer with a sulfonic group-containing monomer such as vinylsulfonic acid, allylsulfonic acid or 2-acrylamido-2-methylpropanesulfonic acid. These polymers are not so effective as corrosion inhibitors, and always require the existence of a certain level of hardness components (more than 200 mg as CaCO₃/liter) in water in order to work properly as corrosion inhibitors. Thus, this method is not established as a perfect corrosion control method for highly corrosive water containing little if any hardness components. When the water system is run intermittently, the corrosion control performance of these polymers further deteriorates unless a given level of water flow velocity (at least 0.5 m/sec) can be secured.

An object of the present invention, which eliminates the foregoing disadvantages of the prior art, is to provide a corrosion inhibitor (anticorrosive) capable of being safely used with a decrease in loading on the environment while maintaining the same level of corrosion control performance as those of conventional corrosion inhibitors for water systems and a corrosion control method using the same.

### SUMMARY OF THE INVENTION

The present invention relates to corrosion inhibitors and corrosion control, or corrosion-proofing, methods for metals in water systems, and particularly to organic corrosion inhibitors and corrosion control methods whereby corrosion of ferreous metal and nonferrous metal members can be effectively prevented even in highly corrosive cooling water having a low hardness (at most 200 mg as CaCO_{3/}liter in total hardness). This invention can be applied mainly to the field of cooling water treatment systems, but can also be applied to the whole fields of various water treatment systems such as wastewater treatment systems, industrial water treatment systems, and deionized water production systems.

### DETAILED DESCRIPTION

As a result of intensive investigations with a view to solving the foregoing problems on condition that use is essentially made of an organic compound(s) alone, the inventors of this invention have succeeded in finding out environmentally safe organic corrosion inhibitors wherein use is not substantially made of environmentally unfriendly. molybdates, nitrites, etc., but which exhibit a high corrosion control performance for highly corrosive water systems, such as a cooling water system, wherein the quantity of hardness components such as calcium and magnesium is small (at most 200 mg as CaCO₃/liter) and a water flow velocity equal to or higher than a given velocity (at least 0.5 m/sec) cannot be secured; and corrosion control methods using the same.

Specifically, the present invention provides an organic corrosion inhibitor for water systems, comprising at least one carboxylic acid compound selected from the group consisting of aliphatic monocarboxylic acids with even-numbered carbon atoms and salts thereof, represented by the following formula (1):
CH₃—(CH₂)m-COOX¹ (1)
(wherein m stands for 2, 4, 6, 8 or 10, and X¹ stands for a hydrogen atom, a monovalent or bivalent metal atom, an ammonium group or an organic ammonium group),and sebacic acid and salts thereof (provided that the salts are of a monovalent or bivalent metal, ammonium or an organic ammonium).

The present invention also provides an organic corrosion inhibitor for water systems, comprising at least one carboxylic acid compound selected from the group consisting of aliphatic monocarboxylic acids and salts thereof, represented by the following formula (2):
CH₃—(CH₂)n-COOX² (2)
(wherein n stands for an integer of 2 to 10, and X² stands for a hydrogen atom, a monovalent or bivalent metal atom, an ammonium group or an organic ammonium group),and sebacic acid and salts thereof (provided that the salts are of a monovalent or bivalent metal, ammonium or an organic ammonium); and at least one oxy- or poly-carboxylic acid compound selected from the group consisting of aliphatic oxycarboxylic acids and salts thereof (provided that the salts are of a monovalent or bivalent metal, ammonium or an organic ammonium), and homo- or co-polymers of at least one carboxyl group-containing monomer, copolymers of at least one carboxyl group-containing monomer with at least one sulfonic group-containing monomer and salts thereof (provided that the salts are of a monovalent or bivalent metal, ammonium or an organic ammonium).

Monovalent or bivalent metal atoms that may replace the hydrogen atom of the carboxyl or sulfonic group to form a salt include Na, K, Ca, Mg, etc. Preferable organic ammonium groups that may replace the hydrogen atom of the carboxyl or sulfonic group to form a salt include (hydroxy)alkylammonium groups having an alkyl and/or hydroxyalkyl group(s) with 1 to 4 carbon atoms. The salts of sebacic acid, aliphatic oxycarboxylic acids having at least two carboxyl groups or the (co)polymers may not always have the hydrogen atoms of all the acid groups each replaced with a monovalent or bivalent metal atom, an ammonium group or an organic ammonium group, and may have a plurality of kinds of such atoms and/or groups for hydrogen atoms of the acid groups.

At least one carboxylic acid compound selected from among aliphatic monocarboxylic acids with even-numbered carbon atoms and salts thereof, represented by the formula (1), and sebacic acid and salts thereof (as claimed in claim 1) can exhibit a sufficient corrosion-proofing effect by itself. At least one carboxylic acid compound selected from among aliphatic monocarboxylic acids and salts thereof, represented by the formula (2), and sebacic acid and salts thereof, when combined with at least one specific oxy- or poly-carboxylic acid compound (as claimed in claim 6), can exhibit a sufficient corrosion-proofing effect even if the amount of the carboxylic acid compound is decreased, for example, to a level of ½ to ⅕ as compared with the former case where use is made of at least one carboxylic acid compound selected from among aliphatic monocarboxylic acids of the formula (1), sebacic acid and salts thereof.

In the present invention, the corrosion inhibitors are “organic.” The meaning of “organic” is to indicate virtual freedom from inorganic components, but is not intended to exclude using any inorganic components to such an extent that the purpose of this invention is not spoiled. Specifically, the phosphorus compound content of the organic corrosion inhibitor of this invention is preferably substantial zero. Specific examples of the phosphorus compound include orthophosphates, polyphosphates, phosphonates, phosphorus-containing polymers and the like, which are used in conventional corrosion inhibitors. These phosphorus compounds have hitherto been considered especially effective ingredients to prevent corrosion in cooling water of low to medium concentration having a hardness of about 20 to about 200 mg as CaCO₃/liter. The “phosphorus compound content of substantial zero” covers a case where no phosphorus compounds are contained, and a case where any phosphorus compounds are so scarcely contained, for example, to be capable of being assumed that they do not substantially bring about scaling, e.g., on high-temperature portions of cooling equipment or the like and actual eutrophication even if discharged into sea, rivers, lakes and marshes. The heavy metals content of the organic corrosion inhibitor of this invention also is preferably substantial zero. Specific examples of heavy metals include zinc compounds such as zinc salts, molybdenum compounds, chromium compounds, etc., that are conventional anticorrosive ingredients. The “heavy metals content of substantial zero” covers a case where no heavy metals are contained, and a case where heavy metals are so scarcely contained to be capable of being assumed that they do not bring about actual environmental pollution even if discharged out of the system.

The organic corrosion inhibitor of the present invention is generally provided in the form of a blend, the blending composition of which is, for example, such that the foregoing ingredients are blended at the following proportions based on the total weight of the corrosion inhibitor composition from the standpoint of corrosion control, scaling prevention, etc. Where a carboxylic acid compound(s) that is at least one of aliphatic monocarboxylic acids of the formula (1) with even-numbered carbon atoms, sebacic acid and salts thereof is used without using any oxy- or poly-carboxylic acid compounds, the carboxylic acid compound content of the corrosion inhibitor of this invention is preferably 1.5 to 80 wt. %, more preferably 6 to 60 wt. %, based on the total weight. When the carboxylic acid compound content is less than 1.5 wt. %, no sufficient corrosion-proofing effect may be expected in some cases. When it exceeds 80 wt. %, the chemical agent is undesirably destabilized with a concomitant cost increase. Where a carboxylic acid compound(s) that is at least one of aliphatic monocarboxylic acids of the formula (2), sebacic acid and salts thereof is used together with the oxy- or poly-carboxylic acid compound(s), the carboxylic acid compound content of the corrosion inhibitor of this invention is preferably 1 to 50 wt. %, more preferably 5 to 30 wt. %, based on the total weight. When the carboxylic acid compound content is less than 1 wt. %, no sufficient corrosion-proofing effect may be expected in some cases. When it exceeds 50 wt. %, the chemical agent is undesirably destabilized with a concomitant cost increase. In this case, the oxy- or poly-carboxylic acid compound content is preferably 0.5 to 30 wt. %, more preferably 1 to 10 wt. %, based on the total weight. When the content is less than 0.5 wt. %, no sufficient corrosion-proofing effect may be expected in some cases. When it exceeds 30 wt. %, the chemical agent is undesirably destabilized with a concomitant cost increase. When an azole compound is further blended, the content thereof is preferably 0.01 to 10 wt. % based on the total weight. When an antifungal agent is further blended, the content thereof is preferably 1 to 30 wt. % based on the total weight. The organic corrosion inhibitor (blend) of this invention usually contains water. The water content is preferably 20 to 95 wt. %, more preferably 40 to 90 wt. %, further preferably 60 to 80 wt. %. Incidentally, in the case of a multicomponent type corrosion inhibitor such as a two-component type one (as claimed in claim 6), the components of the corrosion inhibitor of this invention, even if separately added to a water system to be treated, can of course secure the same effect as in the case of the blend, and will fall within the scope of this invention as soon as all the components are added to the water system to be treated. In this case, it goes without saying that the respective proportions of the components preferably correspond to the above-mentioned proportions.

The organic corrosion inhibitor (blend) of this invention may have an antifungal agent blended therein. From the standpoint of effect and the like, the service concentration of the corrosion inhibitor (blend) of this invention should usually vary depending on whether or not the corrosion inhibitor contains the antifungal agent. Accordingly, the present invention further provides a corrosion control method for water systems characterized in that the organic corrosion inhibitor of the present invention is used at a retained concentration of 50 to 4,000 mg/liter in a water system when said organic corrosion inhibitor contains no antifungal agent; and a corrosion control method for water systems characterized in that the organic corrosion inhibitor of the present invention is used at a retained concentration of 100 to 8,000 mg/liter in a water system when said organic corrosion inhibitor contains an antifungal agent.

Modes for carrying out the present invention will now be described, but should not be construed as limiting the scope of this invention. The corrosion control method of this invention, wherein the organic corrosion inhibitor of this invention is used, can be applied to the whole fields of various water treatment systems such as cooling water treatment systems, wastewater treatment systems, industrial water treatment systems, and deionized water production systems in order to prevent corrosion of metal members in such systems, and can favorably exhibit an excellent effect when used in cooling water systems.

Examples of the aliphatic monocarboxylic acids with even-numbered carbon atoms, represented by the formula (1), include hexanoic, octanoic, decanoic and lauric acids, among which octanoic and decanoic acids are especially preferred. These are linear aliphatic monocarboxylic acids occurring in the nature, and hence are easily available. Incidentally, when the aliphatic monocarboxylic acids with even-numbered carbon atoms are used singly as the corrosion inhibitor, the concentration thereof in a water system is preferably at least 300 mg/liter, more preferably at least 400 mg/liter.

Examples of the aliphatic monocarboxylic acids of the formula (2) include hexanoic, octanoic, decanoic, nonanoic and lauric acids, among which octanoic and decanoic acids are especially preferred. The aliphatic monocarboxylic acids of the formula (2), of which linear aliphatic monocarboxylic acids as represented by the formula (2) are preferred, may sometimes have one or two hydrogen atoms thereof substituted with a methyl group bonded thereto as a side chain. Incidentally, in the present invention, sebacic acid can generally exhibit the same corrosion-proofing effect as octanoic acid, but has lower water solubility than octanoic acid. Thus, it is desirable that some measure such as heating or combined use of sebacic acid with a small amount of an organic solvent be taken in order to improve the water solubility of sebacic acid.

Examples of the aliphatic oxycarboxylic acids include aliphatic oxy-mono-, -di- or -tri-carboxylic acids such as malic, tartaric, citric, lactic, gluconic and heptonic acids.

Examples of the carboxyl group-containing monomer include maleic acid (anhydride), acrylic acid, methacrylic acid, and itaconic acid. Examples of the sulfonic group-containing monomer include vinylsulfonic, allylsulfonic, 2-acrylamido-2-methylpropanesulfonic and styrenesulfonic acids. Polycarboxylic acids, obtained by (co)polymerizing the above-mentioned monomer(s), and salts thereof (polycarboxylic acid compounds) are water-soluble polyelectrolytes. Their average molecular weight is preferably 500 to 10,000. In the case of a copolymer of the carboxyl group-containing monomer(s) with the sulfonic group-containing monomer(s), the former:latter weight ratio is preferably 50:50 to 95:5 from the standpoint of effective scaling prevention and the like.

Examples of the carboxyl group-containing monomer include maleic acid (anhydride), acrylic acid, methacrylic acid, and itaconic acid. Examples of the sulfonic group-containing monomer include vinylsulfonic, allylsulfonic, 2-acrylamido-2-methylpropanesulfonic and styrenesulfonic acids. Polycarboxylic acids, obtained by (co)polymerizing the above-mentioned monomer(s), and salts thereof (polycarboxylic acid compounds) are water-soluble polyelectrolytes. Their average molecular weight is preferably 500 to 10,000. In the case of a copolymer of the carboxyl group-containing monomer(s) with the sulfonic group-containing monomer(s), the former:latter weight ratio is preferably 50:50 to 95:5 from the standpoint of effective scaling prevention and the like.

Specific examples of the polycarboxylic acid compounds that may be blended with the carboxylic acid compound(s) that is at least one of the aliphatic monocarboxylic acids of the formula (2), sebacic acid and salt(s) thereof include polyacrylic acid, polymaleic acid, copolymers of acrylic acid with 2-acrylamido-2-methylpropanesulfonic acid, and sodium salts thereof. They can also secure a scaling control effect when used.

An azole compound as a corrosion inhibitor for cupreous metals such as copper and copper alloys is preferably further jointly used or blended with the indispensable ingredients of the organic corrosion inhibitor of this invention though such use of an azole compound depends on the kind of water treatment system, such as a cooling water system. Examples of the azole compound include benzotriazole, tolyltriazole, and aminotriazole. They may be used alone or in mixture. Benzotriazole and tolyltriazole are preferred.

In some cases, an antifungal agent is preferably further jointly used or blended with the indispensable ingredients of the organic corrosion inhibitor of this invention in order to prevent occurrence of sliming and microorganism corrosion. For example, an organic sulfur and nitrogen compound can be used as the antifungal agent, specific examples of which include 2-methyl-3-isothiazolone, 5-chloro-2-methyl-3-isothiazolone, and 4,5-dichloro-2-n-octyl-3-isothiazolone. They may be used alone or in mixture. The amount of the azole compound to be blended is preferably 0.01 to 10 wt. % based on the total weight of the corrosion inhibitor (blend) of this invention from the standpoint of effect and cost. The amount of the antifungal agent to be blended is preferably 1 to 30 wt. % based on the total weight of the corrosion inhibitor (blend) of this invention from the standpoint of effect and cost.

The organic corrosion inhibitor (blend) of this invention may as well be used usually at a concentration of 50 to 4,000 mg/liter in a water system when it does not contain the antifungal agent, and usually at a concentration of 100 to 8,000 mg/liter in a water system when it contains the antifungal agent.

### EXAMPLES

The following Examples will specifically illustrate the present invention, but should not be construed as limiting the scope of this invention. Incidentally, in some temporary “Examples” in Tables 2 to 5, wherein use was made of an anticorrosive ingredient falling within the scope of the present invention but a proper choice was not made of service conditions such as a proper concentration of the anticorrosive ingredient, good results were not necessarily obtained but were obtained if the service conditions were proper.

Examples 1 to 32 and Comparative Examples 1 to 12

When the water flow was continuous in velocity, the corrosion control performance was evaluated in the following manner.

Organic corrosion inhibitors containing an ingredient(s) as listed in Tables 2 and 3 were prepared, and added to test water in such a manner that the concentration(s) of added ingredient(s) was as listed in Tables 2 and 3. Water samples thus prepared were used to measure the corrosion rate of soft steel by the mass loss method in accordance with the industrial water corrosion testing method (JIS-K0100). More specifically, a disk having a test specimen fixed thereon was immersed into each water sample, and revolved at a given speed to effect stirring. Such immersion with stirring was continued for 7 days. After 7 days, the specimen was taken out, stripped of rust, and weighed. The corrosion rate was determined from a difference of that weight from the weight of the specimen measured before the start of the test.

[Test Conditions]

Test Water: Toda city raw water and concentrated water thereof obtained ata concentration rate of 2, or by 2 cycles of concentration (The water qualities are shown in Table 1.)
Water Temperature: 35° C.
Stirring Speed: 150 rpm
Test Specimen: soft steel SS400 (10×30×50 mm, #400)

Test Period: 7 days

TABLE 1

| | Toda City | Water Concentrated |
|---|---|---|
| | Raw Water | at Rate of 2 |
| pH | 7.2 | 7.4 |
| Electric Conductivity | 250 | 500 |
| Acid Consumption (pH = 4.8) | 45 | 90 |
| Total Hardness | 80 | 160 |
| Calcium Hardness | 60 | 120 |
| Silica | 20 | 40 |
| Chloride Ions | 20 | 40 |

Here, units for items in Table 1 are “μS/cm” for electric conductivity, “mg as CaCO₃/liter” for acid consumption (pH=4.8), total hardness and calcium hardness, “mg as SiO₂/liter” for silica, and “mg as Cl/liter” for chloride ions.

Test results are shown in Tables 2 and 3. Incidentally, in Tables 2 to 5, “PAA” stands for polyacrylic acid with an average molecular weight of 4,500, “AAB” for an acrylic bipolymer with an average molecular weight of 4,500 wherein acrylic acid: 2-acrylamido-2-methylpropanesulfonic acid=75:25 (weight ratio), “PMAA” for polymaleic acid with an average molecular weight of 1,000, and “MDD” for mg/dm²·day as the unit of corrosion rate.

TABLE 2

| | | Concentration of Added Anticorrosive | | | | | Specimen |
|---|---|---|---|---|---|---|---|
| | Toda City | Ingredient in water (ppm) | | | | | Weight |
| | Water Concn. | Octanoic | Decanoic | Tartaric | | | Loss |
| | Rate | Acid | Acid | Acid | PAA | AAB | (MDD) |
| Not added | 1 | | | | | | 210.40 |
| Ex. 1 | 1 | 500 | | | | | 1.0 |
| Ex. 2 | 1 | 200 | | | | | 27.1 |
| Ex. 3 | 1 | | 500 | | | | 0.9 |
| Ex. 4 | 1 | | 200 | | | | 23.6 |
| Comp. Ex. 1 | 1 | | | 200 | | | 35.6 |
| Comp. Ex. 2 | 1 | | | | 200 | | 17.4 |
| Comp. Ex. 3 | 1 | | | | | 200 | 15.8 |
| Ex. 5 | 1 | 200 | | 20 | | | 1.7 |
| Ex. 6 | 1 | 200 | | | 20 | | 1.5 |
| Ex. 7 | 1 | 200 | | | | 20 | 1.9 |
| Ex. 8 | 1 | | 200 | 20 | | | 1.6 |
| Ex. 9 | 1 | | 200 | | 20 | | 1.8 |
| Ex. 10 | 1 | | 200 | | | 20 | 1.8 |
| Not added | 2 | | | | | | 124.7 |
| Ex. 11 | 2 | 500 | | | | | 1.8 |
| Ex. 12 | 2 | 200 | | | | | 16.3 |
| Ex. 13 | 2 | | 500 | | | | 1.9 |
| Ex. 14 | 2 | | 200 | | | | 14.5 |
| Comp. Ex. 4 | 2 | | | 200 | | | 29.9 |
| Comp. Ex. 5 | 2 | | | | 200 | | 9.8 |
| Comp. Ex. 6 | 2 | | | | | 200 | 8.4 |
| Ex. 15 | 2 | 200 | | 20 | | | 0.8 |
| Ex. 16 | 2 | 200 | | | 20 | | 0.7 |
| Ex. 17 | 2 | 200 | | | | 20 | 0.8 |
| Ex. 18 | 2 | | 200 | 20 | | | 0.6 |
| Ex. 19 | 2 | | 200 | | 20 | | 0.8 |
| Ex. 20 | 2 | | 200 | | | 20 | 0.7 |

TABLE 3

| | | Concentration of Added Anticorrosive | | | | | Specimen |
|---|---|---|---|---|---|---|---|
| | Toda City | Ingredient in Water (ppm) | | | | | Weight |
| | Water Concn. | Octanoic | Decanoic | Gluconic | Heptonic | | Loss |
| | Rate | Acid | Acid | Acid | Acid | PMAA | (MDD) |
| Comp. Ex. 7 | 1 | | | 200 | | | 23.6 |
| Comp. Ex. 8 | 1 | | | | 200 | | 26.7 |
| Comp. Ex. 9 | 1 | | | | | 200 | 44.5 |
| Ex. 21 | 1 | 200 | | 20 | | | 1.4 |
| Ex. 22 | 1 | 200 | | | 20 | | 1.6 |
| Ex. 23 | 1 | 200 | | | | 20 | 1.9 |
| Ex. 24 | 1 | | 200 | 20 | | | 1.7 |
| Ex. 25 | 1 | | 200 | | 20 | | 1.4 |
| Ex. 26 | 1 | | 200 | | | 20 | 1.8 |
| Comp. Ex. 10 | 2 | | | 200 | | | 13.6 |
| Comp. Ex. 11 | 2 | | | | 200 | | 14.7 |
| Comp. Ex. 12 | 2 | | | | | 200 | 16.3 |
| Ex. 27 | 2 | 200 | | 20 | | | 1.2 |
| Ex. 28 | 2 | 200 | | | 20 | | 0.9 |
| Ex. 29 | 2 | 200 | | | | 20 | 1.0 |
| Ex. 30 | 2 | | 200 | 20 | | | 1.0 |
| Ex. 31 | 2 | | 200 | | 20 | | 0.9 |
| Ex. 32 | 2 | | 200 | | | 20 | 0.7 |

It was found from Examples 1, 3, 11 and 13 in Table 2 that either octanoic acid or decanoic acid alone, when used at a concentration of about 500 ppm (mg/liter), could show an excellent corrosion-proofing effect in a corrosion test that was carried out in a water system involving a given level of constant water flow velocity. When Examples 2, 4, 12 and 14 were compared with Comparative Examples 2, 3, 5, 6, 9 and 12 in Tables 2 and 3, it was found that polycarboxylic acid compounds (PAA, AAB) were a little better in corrosion-proofing effect than octanoic acid and decanoic acid in corrosion tests that were carried out in a water system involving a given level of constant water flow velocity, provided that their concentrations were the same. When Examples 5 to 10 and 15 to 32 were compared with Comparative Examples 2, 3, 5, 6, 9 and 12 in Tables 2 and 3, however, it was found that either octanoic acid or decanoic acid, when used in combination with a small amount of tartaric acid, gluconic acid, heptonic acid or a polycarboxylic acid compound (PAA, AAB, PMAA), could secure a conspicuous corrosion control performance.

Examples 33 to 64 and Comparative Examples 13 to 24

When the water flow varied intermittently in velocity, the corrosion control performance was evaluated in the following manner.

Organic corrosion inhibitors containing an ingredient(s) as listed in Tables 4 and 5 were prepared, and added to test water in such a manner that the concentration(s) of added ingredient(s) was as listed in Tables 4 and 5. Water samples thus prepared were used to measure the corrosion rate of soft steel by the mass loss method in accordance with the industrial water corrosion testing method (JIS-K0100). More specifically, a disk having a test specimen fixed thereon was immersed into each water sample, and revolved at a given speed to effect stirring. Such immersion with stirring was continued for 1 day, the revolution was stopped (at rest at a flow velocity of zero), and immersion at rest was continued for 6 days. After these 7 days, the specimen was taken out, stripped of rust, and weighed. The corrosion rate was determined from a difference of that weight from the weight of the specimen measured before the start of the test.

[Test Conditions]

Test Water: Toda city raw water and concentrated water thereof obtained at a concentration rate of 2, or by 2 cycles of concentration (The water qualities are shown in Table 1.)
Water Temperature: 35° C.
Stirring Speed: 150 rpm (during stirring)
Test Specimen: soft steel SS400 (10×30×50 mm, #400)

Test Period: 7 days (one day of stirring and 6 days of rest thereafter)

TABLE 4

| | | Concentration of Added Anticorrosive | | | | | Specimen |
|---|---|---|---|---|---|---|---|
| | Toda City | Ingredient in Water (ppm) | | | | | Weight |
| | Water Concn. | Octanoic | Decanoic | Tartaric | | | Loss |
| | Rate | Acid | Acid | Acid | PAA | AAB | (MDD) |
| Not added | 1 | | | | | | 198.0 |
| Ex. 33 | 1 | 500 | | | | | 0.9 |
| Ex. 34 | 1 | 200 | | | | | 24.6 |
| Ex. 35 | 1 | | 500 | | | | 0.6 |
| Ex. 36 | 1 | | 200 | | | | 24.5 |
| Comp. Ex. 13 | 1 | | | 200 | | | 68.6 |
| Comp. Ex. 14 | 1 | | | | 200 | | 63.6 |
| Comp. Ex. 15 | 1 | | | | | 200 | 62.8 |
| Ex. 37 | 1 | 200 | | 20 | | | 1.5 |
| Ex. 38 | 1 | 200 | | | 20 | | 1.3 |
| Ex. 39 | 1 | 200 | | | | 20 | 1.4 |
| Ex. 40 | 1 | | 200 | 20 | | | 1.6 |
| Ex. 41 | 1 | | 200 | | 20 | | 1.4 |
| Ex. 42 | 1 | | 200 | | | 20 | 1.2 |
| Not added | 2 | | | | | | 100.2 |
| Ex. 43 | 2 | 500 | | | | | 3.0 |
| Ex. 44 | 2 | 200 | | | | | 17.1 |
| Ex. 45 | 2 | | 500 | | | | 3.2 |
| Ex. 46 | 2 | | 200 | | | | 16.3 |
| Comp. Ex. 16 | 2 | | | 200 | | | 45.7 |
| Comp. Ex. 17 | 2 | | | | 200 | | 41.5 |
| Comp. Ex. 18 | 2 | | | | | 200 | 40.9 |
| Ex. 47 | 2 | 200 | | 20 | | | 0.7 |
| Ex. 48 | 2 | 200 | | | 20 | | 0.8 |
| Ex. 49 | 2 | 200 | | | | 20 | 0.9 |
| Ex. 50 | 2 | | 200 | 20 | | | 1.0 |
| Ex. 51 | 2 | | 200 | | 20 | | 0.8 |
| Ex. 52 | 2 | | 200 | | | 20 | 0.8 |

TABLE 5

| | | Concentration of Added Anticorrosive | | | | | Specimen |
|---|---|---|---|---|---|---|---|
| | Toda City | Ingredient in Water (ppm) | | | | | Weight |
| | Water Concn. | Octanoic | Decanoic | Gluconic | Heptonic | | Loss |
| | Rate | Acid | Acid | Acid | Acid | PMAA | (MDD) |
| Comp. Ex. 19 | 1 | | | 200 | | | 54.8 |
| Comp. Ex. 20 | 1 | | | | 200 | | 50.3 |
| Comp. Ex. 21 | 1 | | | | | 200 | 77.2 |
| Ex. 53 | 1 | 200 | | 20 | | | 1.6 |
| Ex. 54 | 1 | 200 | | | 20 | | 1.8 |
| Ex. 55 | 1 | 200 | | | | 20 | 1.4 |
| Ex. 56 | 1 | | 200 | 20 | | | 1.4 |
| Ex. 57 | 1 | | 200 | | 20 | | 1.2 |
| Ex. 58 | 1 | | 200 | | | 20 | 0.9 |
| Comp. Ex. 22 | 2 | | | 200 | | | 51.3 |
| Comp. Ex. 23 | 2 | | | | 200 | | 40.2 |
| Comp. Ex. 24 | 2 | | | | | 200 | 60.2 |
| Ex. 59 | 2 | 200 | | 20 | | | 1.1 |
| Ex. 60 | 2 | 200 | | | 20 | | 1.2 |
| Ex. 61 | 2 | 200 | | | | 20 | 0.9 |
| Ex. 62 | 2 | | 200 | 20 | | | 1.4 |
| Ex. 63 | 2 | | 200 | | 20 | | 1.3 |
| Ex. 64 | 2 | | 200 | | | 20 | 0.8 |

It was found from Examples 33, 35, 43 and 45 in Table 4 that either octanoic acid or decanoic acid alone, when used at a concentration of about 500 ppm (mg/liter), could show an excellent corrosion-proofing effect even in a corrosion test that was carried out in a water system wherein a given level of water flow velocity could not always be secured. When Examples 34, 36, 44 and 46 were compared with Comparative Examples 14, 15, 17, 18 and 21 in Tables 4 and 5, it was found that polycarboxylic acid compounds (PAA, AAB, PMAA) were markedly lowered in corrosion-proofing effect as compared with octanoic acid and decanoic acid in corrosion tests that were carried out in a water system wherein a given level of water flow velocity could not always be secured, provided that their concentrations were the same. It was also found that either octanoic acid or decanoic acid, when used in combination with a small amount of tartaric acid, gluconic acid, heptonic acid or a polycarboxylic acid compound (PAA, AAB, PMAA), could secure a conspicuous corrosion control performance (see Examples 37 to 42 and 47 to 64).

According to the present invention, there are provided safe organic corrosion inhibitors and corrosion control methods that are environmentally friendly even for highly corrosive water. More specifically, even if substantial use is made of none of molybdates, nitrites, etc., which impose unfriendly loads on the environment, the organic corrosion inhibitors and corrosion control methods of the present invention, which are safe for the environment, can exhibit a high corrosion control performance even against water systems, such as a cooling water system, which are low in concentration of hardness components such as calcium and magnesium (at most 200 mg as CaCO₃/liter) and hence are highly corrosive, and/or which cannot secure a water flow velocity higher than a given velocity (at least 0.5 m/sec).

In order to control corrosion against metal members, the organic corrosion inhibitors and corrosion control methods of the present invention can be applied to the whole fields of various water treatment systems such as cooling water treatment systems, wastewater treatment systems, industrial water treatment systems, and deionized water production systems, and can especially advantageously be used in cooling water systems using low-hardness water and cooling water systems incapable of always securing a water flow velocity above a given level.

1. An organic corrosion inhibitor as claimed in claim 6 wherein:
(1) said at least one carboxylic acid compound is selected from the group consisting of octanoic acid, decanoic acid, and salts thereof;
(2) said at least one polycarboxylic acid compound is selected from the group consisting of polyacrylic acid with an average molecular weight of 500 to 10,000, an acrylic bipolymer with an average molecular weight of 500 to 10,000 wherein acrylic acid: 2-acrylamido-2-methyipropanesulfonic acid =75:25 (weight ratio), polymaleic acid with an average molecular weight of 500 to 10,000, and salts thereof.

2. An organic corrosion inhibitor as claimed in claim 1, which further comprises an azole compound and has an azole compound content of 0.01 to 20 wt. %.

3. An organic corrosion inhibitor as claimed in claim 6, which is in the form of a blend wherein the at least one carboxylic acid compound content is 1 to 50 wt. %. the at least one polycarboxylic acid compound content is 0.5 to 30 wt. %, and the water content is 20 to 95 wt. %.

4. An organic corrosion inhibitor as claimed in claim 1, which further comprises an antifungal agent and has an antifungal agent content of 1 to 30 wt. %.

5. (cancelled)

6. An organic corrosion inhibitor for use in cooling water systems including closed cooling water systems, cool or warm air-conditioning water systems, wastewater treatment systems, industrial water treatment systems, and deionized water production systems, comprising at least one carboxylic acid compound selected from the group consisting of aliphatic monocarboxylic acids and salts thereof, represented by the following formula (2):
CH₃—(CH₂)n-COOX² (2)
wherein n stands for an integer of 2 to 10, and X² stands for a hydrogen atom, a monovalent or bivalent metal atom, an ammonium group or an organic ammonium group, and sebacic acid and salts thereof, provided that the salts are of a monovalent or bivalent metal, ammonium or an organic ammonium; and
at least one oxy or poly carboxylic polycarboxylic acid compound selected from the group consisting of homo- or co-polymers of at least one carboxyl group-containing monomer, copolymers of at least one carboxyl group-containing monomer with at least one sulfonic group-containing monomer and salts thereof, provided that the salts are of a monovalent or bivalent metal, ammonium or an organic ammonium; and
wherein use is not substantially made of molybdates, nitirites, phosphorus, and zinc salts.

7. An organic corrosion inhibitor as claimed in claim 6, which further comprises an azole compound and has an azole compound content of 0.01 to 20 wt. %.

8. An organic corrosion inhibitor as claimed in claim 7, wherein said azole compound is at least one of benzotriazole and tolyltriazole.

9. An organic corrosion inhibitor as claimed in claim 6, which further comprises an antifungal agent and has an antifungal agent content of 1 to 30 wt. %.

10. An organic corrosion inhibitor as claimed in claim 9, wherein said antifungal agent is an organic sulfur and nitrogen compound.

11. A corrosion control method, comprising using an organic corrosion inhibitor of claim 1 at a retained concentration of 50 to 4,000 mg/liter in a water system.

12. A corrosion control method, comprising using an organic corrosion inhibitor of claim 2 at a retained concentration of 50 to 4,000 mg/liter in a water system.

13. (cancelled)

14. A corrosion control method, comprising using an organic corrosion inhibitor of claim 4 at a retained concentration of 100 to 8,000 mg/liter in a water system.

15. (cancelled)

16. A corrosion control method, comprising using an organic corrosion inhibitor of claim 6 at a retained concentration of 50 to 4,000 mg/liter in a water system.

17. A corrosion control method, comprising using an organic corrosion inhibitor of claim 7 at a retained concentration of 50 to 4,000 mg/liter in a water system.

18. A corrosion control method, comprising using an organic corrosion inhibitor of claim 8 at a retained concentration of 50 to 4,000 mg/liter in a water system.

19. A corrosion control method, comprising using an organic corrosion inhibitor of claim 9 at a retained concentration of 100 to 8,000 mg/liter in a water system.

20. A corrosion control method, comprising using an organic corrosion inhibitor of claim 10 at a retained concentration of 100 to 8,000 mg/liter in a water system.
